(19) United States
(12) Patent Application Publication
(10) Pub. No.: US 2026/0023574 A1
(43) Pub. Date: Jan. 22, 2026

(54) RUNTIME PROCESS RECONFIGURATION

(71) Applicant: INTERNATIONAL BUSINESS MACHINES CORPORATION, Armonk, NY (US)

(72) Inventors: Faried ABRAHAMS, Laytonsville, MD (US); Gandhi SIVAKUMAR, Mountain View, CA (US); Balaji Sankar KUMAR, Bangalore (IN); Manu K M, Bangalore (IN)

(21) Appl. No.: 18/774,139

(22) Filed: Jul. 16, 2024

(51) Int. Cl. G06F 9/445; G06F 9/38

(52) U.S. Cl. CPC G06F 9/44505; G06F 9/3838

(57) ABSTRACT

Computer implemented methods, systems, and computer program products include program code executing on a processor(s) initializes a process model for runtime reconfiguration. The program code extracts dependencies for components comprising the process model. The program code generates or updates a dependency graph representing the dependencies, based on the extracting. The program code initializes a protocol across a stack for executing the process based on the dependencies. The program code, after initializing initiates the transaction. During runtime, the program code receives an input related to the transaction performed by the process model. The program code cognitively analyzes the input utilizing a large language model (LLM) to determine an urgency level for the transaction. The program code determines that the urgency level is above a pre-determined threshold. The program code reconfigures the process model to comport with the urgency level.

### BACKGROUND

The present invention relates generally to the field of data machine learning, and in particular, to a method for re-configuring a process model during runtime based on cognitively analyzing sentiments.

The term choreography, which is most closely associated with dance, can be used in data maintenance, integrity, and security contexts. For example, in Extract, Transform, Load (ETL) pipelines, data sources can be understood as diverse dancers, each with unique characteristics, while transformations are the choreography that harmonizes and aligns their movements. Dependencies represent the coordination essential for successful data performance, addressing errors and challenges, and integrating data for informed decisions.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Large language models (LLMs) are deep learning models that are pre-trained on vast amounts of data. Transformer LLMs refer to LLMs that are capable of unsupervised training and can learn to understand basic grammar, languages, and knowledge. The underlying transformer for a transformer LLM is a set of neural networks that consist of an encoder and a decoder with self-attention capabilities. The encoder and decoder extract meanings from a sequence of text and understand the relationships between words and phrases in it. Unlike earlier recurrent neural networks (RNN) that sequentially process inputs, transformers process entire sequences in parallel. In addition to utilizing CPUs to train LLMs, data scientists can also use GPUs for training transformer based LLMs, significantly reducing the training time. Chatbots are interfaces utilized to interact with LLMs.

Natural language understanding (NLU) uses deep learning to extract meaning and metadata from unstructured text data. For example, NLU can be used to extract categories, classification, entities, keywords, sentiment, emotion, relations and/or syntax from text. NLU capabilities can be implemented as a machine learning system that can include a neural network (NN). NLU technologies can utilize supervised, semi-supervised, or unsupervised deep learning through a single- or multi-layer NN to classify data. The deep learning capabilities use the NN to identify and weight connections between data points. The use of deep learning, including in NLU, is understood as a form of artificial intelligence. A subset of NLU is natural language processing (NLP). NLP is a subfield of AI and computer science that focuses on the tokenization of data and specifically, the parsing of human language, whether spoken or text, into its elemental pieces.

### SUMMARY

Shortcomings of the prior art are overcome, and additional advantages are provided through the provision of a computer-implemented method for re-aligning and executing a transaction based on urgency. The method can include: initializing, by one or more processors, the process model for runtime reconfiguration, the initializing comprising: extracting, by the one or more processors, dependencies for components comprising the process model; generating or updating, by the one or more processors, a dependency graph representing the dependencies, based on the extracting; and initializing, by the one or more processors, a protocol across a stack for executing the process based on the dependencies; and initiating, by the one or more processors, the transaction; during runtime, receiving, by the one or more processors, an input related to the transaction performed by the process model; cognitively analyzing, by the one or more processors, the input utilizing a large language model (LLM) to determine an urgency level for the transaction; determining, by the one or more processors, that the urgency level is above a pre-determined threshold; and reconfiguring, by the one or more processors, the process model to comport with the urgency level.

Shortcomings of the prior art are overcome, and additional advantages are provided through the provision of a computer program product for re-aligning and executing a transaction based on urgency. The computer program product comprises a storage medium readable by a one or more processors and storing instructions for execution by the one or more processors for performing a method. The method includes, for instance: initializing, by the one or more processors, the process model for runtime reconfiguration, the initializing comprising: extracting, by the one or more processors, dependencies for components comprising the process model; generating or updating, by the one or more processors, a dependency graph representing the dependencies, based on the extracting; and initializing, by the one or more processors, a protocol across a stack for executing the process based on the dependencies; and initiating, by the one or more processors, the transaction; during runtime, receiving, by the one or more processors, an input related to the transaction performed by the process model; cognitively analyzing, by the one or more processors, the input utilizing a large language model (LLM) to determine an urgency level for the transaction; determining, by the one or more processors, that the urgency level is above a pre-determined threshold; and reconfiguring, by the one or more processors, the process model to comport with the urgency level.

Shortcomings of the prior art are overcome, and additional advantages are provided through the provision of a system for re-aligning and executing a transaction based on urgency. The system includes: a memory, one or more processors in communication with the memory, and program instructions executable by the one or more processors via the memory to perform a method. The method includes, initializing, by the one or more processors, the process model for runtime reconfiguration, the initializing comprising: extracting, by the one or more processors, dependencies for components comprising the process model; generating or updating, by the one or more processors, a dependency graph representing the dependencies, based on the extracting; and initializing, by the one or more processors, a protocol across a stack for executing the process based on the dependencies; and initiating, by the one or more processors, the transaction; during runtime, receiving, by the one or more processors, an input related to the transaction performed by the process model; cognitively analyzing, by the one or more processors, the input utilizing a large language model (LLM) to determine an urgency level for the transaction; determining, by the one or more processors, that the urgency level is above a pre-determined threshold; and reconfiguring, by the one or more processors, the process model to comport with the urgency level.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an illustration of a sample business process model (BPM) that does not include aspects of the examples herein;

FIG. 3 is an illustration of a sample business process model (BPM) that includes various aspects of the present disclosure;

FIG. 4 is a workflow that provides an overview of various aspects performed by the program code (executing on one or more processors) in some embodiments of the present disclosure;

FIG. 5 is a workflow that provides an overview of various aspects performed by the program code (executing on one or more processors) in some embodiments of the present disclosure;

FIG. 6 is a component diagram that illustrates various aspects of some embodiments of the present disclosure; and

FIG. 7 is a workflow that provides an overview of various aspects performed by the program code (executing on one or more processors) in some embodiments of the present disclosure.

### DETAILED DESCRIPTION

The computer-implemented methods, computer program products, and systems described herein align choreography for tasks associated with a transaction. In some examples, program code executing on one or more processors analyzes a plurality of tasks associated with a transaction, determines a sentiment of each task of the plurality of tasks, and assigns a level of urgency to each task based on the sentiment. In some examples, the program code utilizes an LLM to determine the levels of urgency of the tasks. In some examples, the program code automatically re-aligns the choreography of the transaction such that the program code can execute the tasks in accordance with the levels of urgency. In some examples, the program code ascertains a plurality of parameters associated with each task of the plurality of tasks and manages a dependency graph configured to correlate the plurality of parameters and the determined sentiment of each task. The program code can update this graph by applying machine learning algorithms and hence, tune and improve this process in subsequent iterations. The examples herein serve to bridge a known gap between the LLMs and processes, including but not limited to, business processes. In the examples herein, an LLM is aligned to work in concert with a process to identify and prioritize certain processes based on context and requirements.

Transactions can refer to interactions from an end user and/or system to a target system that encompasses a list of components that work together to achieve a specific task. A priority of a given task within a system (the target system) can be understood as a need for elements and/or components in a process to act to urgency. This understanding of task priority is different than a traditional understanding of priority where a task is viewed as being urgent when just one or more components act with urgency. Transaction prioritization in the context of the examples herein can be understood with reference to a banking process model that processes insurance claims and coverages via a chatbot for the end customer. The banking model is offered as a non-limiting example and is provided for illustrative purposes only. In a scenario where the end customer's direct relative encounters an accident and requires urgent (time-sensitive) medical attention, the situation can be resolved utilizing insurance coverage details and/or approvals. The process (alignment choreography) changes based on program code executing in this system determining the priority of a task. When the customer interacts with the chatbot to enquire about the insurance details, the chatbot interacts with an underlying LLM such that the LLM can analyze the input including keywords and/or emotions such that the LLM can determine the urgency of the transaction. Once the system (utilizing the LLM) determines that the transaction is a priority transaction (based on the urgency), the system can take steps to prioritize and/or request prioritization of the transaction. For example, this system could fetch customer details from a CRM from a customer relationship management (CRM) system rather than engage in a usual process, such as a person a step-by-step validation of the customer at every stage. Also, because the system has identified the transaction as being a priority transaction, the system could perform minimal validations and proceed for approvals and processing of insurance, thus deferring the normal procedure.

The examples herein are inextricably tied to computing at least based on utilizing LLMs to change processes within computing systems based on determining prioritization of tasks. In these examples, the program code develops and trains machine learning models including LLMs, with underlying recurrent neural networks (RNNs) and/or convolutional neural network (CNNs), to prioritize tasks and based on whether the program code determines that a task is urgent, to revise (choreograph) processes performed in computing systems (including in enterprise computing systems) in order to complete the task with a choreography that is aligned with the priority of the task. Program code in examples herein revises and executes a process to complete a task based on utilizing an LLM to determine the priority of the task (e.g., based on contextualizing input received by the program code). Specifically, in some examples, the program code in the examples herein utilizes an LLM (which is consistently trained and re-trained through usage), to determine task urgency. The LLM can determine this urgency based on various factors it extracts and analyzes (including by utilizing an underlying neural network), including but not limited to, keywords, contextual information, and/or timing (e.g., hour of the day, etc.). In these examples, the program code communicating with the LLM or of the LLM focuses on a scope of content and provides an urgency level (e.g., based on pre-defined values) as output. The program code obtains the output and based on determining that the urgency is at or above a pre-defined threshold, re-choreographs the processing in the system which would complete the task to complete the task in a manner more aligned with the urgency of the task. The program code continuously updates and refines the urgency classification model to improve accuracy and efficiency.

LLMs are deep learning models that are pre-trained on vast amounts of data. The underlying transformer is a set of neural networks that consist of an encoder and a decoder with self-attention capabilities. The encoder and decoder extract meanings from a sequence of a language input (which can be verbal or written) and understand the relationships between words and phrases in it. Transformer LLMs are capable of unsupervised training and can learn to understand basic grammar, languages, and knowledge. Unlike earlier recurrent neural networks (RNN) that sequentially process inputs, transformers process entire sequences in parallel. This allows the data scientists to use GPUs for training transformer based LLMs, significantly reducing the training time.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. For this reason, LLMs utilized in the examples herein can utilize neural networks to determine priorities of tasks based on inputs, including natural language inputs.

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval. Sentiment recognition is an example of large-scale recognition in which a CNN can be utilized by the program code.

In certain embodiments of the present invention the program code utilizes an RNN. An RNN is a class of NN where connections between units form a directed cycle in order to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. Given that LLMs can receive speech as well as natural language in other formats (e.g., text), including via a chatbot, an RNN can be utilized in various examples herein.

An LLM is a deep learning model, and a deep learning model can refer to a type of classifier. The program code can implement a deep learning model in various forms such as by a neural network (e.g., a CNN, an RNN); LLMs are generally implemented using an NN. In some examples, a deep learning mode includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model. In these examples, the program code can utilize NNs to classify tasks in accordance with perceived urgency and provide output that enables the program code to choreograph processes to perform the task such that the choreography aligns with the urgency of the tasks. For example, the program code can change the process to streamline portions of it to enable an urgent task to finish more quickly.

Not only are the computer-implemented methods, computer program products, and systems described herein inextricably tied to computing, but the computer-implemented methods, computer program products, and systems are also directed to a practical application. In a non-limiting example, the computer-implemented methods, computer program products, and systems described herein comprise program code executing on one or more processors that bridges a known gap in LLM functionality. With the introduction of pre-trained LLMs, there has been a wide range of applications in natural language conversations. These LLMs get deployed in various stages across a process. Though these models do not inherently possess the ability to understand the sense of urgency or prioritize tasks based on emergency, methods can be adapted to sense the urgency by keywords and respond in priority. This imposes a gap when models are hooked to cater to a specific business need based on priority especially when they are deployed as a part of a process. All the elements in the process may need to act to such urgency and this urges for a need of a choreographer that understands the business process models and aligns all elements to act accordingly. In the examples herein, program code executing one or more processors can utilize an LLM to determine task priority and can choreograph a whole of a process, to accomplish a task, based on aligning the entirety of the process to the perceived urgency.

The computer-implemented methods, computer program products, and systems described herein provide significantly more than existing approaches to implementing process changes based on perceived urgency. In the examples herein, program code executing on one or more processors aligns all elements to act to the urgency determined by the program code, either through a centralized control or sequential control. In general, process models, including but not limited to, business process models (BPMs) have multiple components working towards completion of a transaction. Certain of the advantages of the examples herein can be appreciated based on understanding the example of a BPM model of a user interacting with a conversation bot. Using traditional approaches, the components of the BPM act in siloes and a transaction on arrival is processed sequentially as configured. In the examples herein, the program code acts as a choreographer and can directly interact with all components in the BPM. As such, the program code can alter or update the execution paths of transactions based on priority. The program code of the choreographer can utilized one or more of centralized communication and/or sequential communication. Both examples are discussed in more detail herein. Put plainly, there is no system currently that can handle urgency in a transaction of a business process model spanning a spectrum from simple to very complex long running processes. The examples herein address this deficiency including by: 1) utilizing an LLM to identify the urgency and/or sentiments level of a transaction at origin point or at any point of the transaction; and/or 2) initializing a protocol manager to augment additional parameters to handle the request (e.g., choreograph the process as a whole to align with the urgency). To enable LLMs to determine urgency, including more accurately throughout iterative uses, the program code can utilize an LLM based depth control manager to tune the configuration of LLM models or traditional AI models to accommodate the urgency level of the transaction. The program code in the examples herein can also identify changes in a process model, including in a BPM model (e.g., addition and/or removal of nodes) and re-initiate the learning of the new environment. The examples herein also provide significantly more than existing approaches because the examples herein enhance the self-intelligence of the LLM models by adding an urgency factor as embeddings to the model. The sense of acting to urgency from LLM models can help reduce human intervention and can bridge the gap between business process models and LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

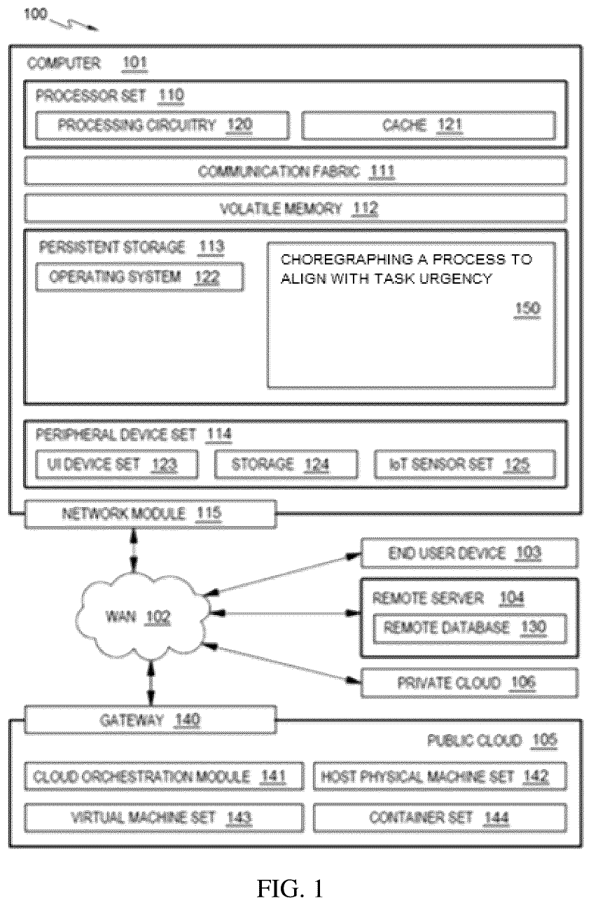

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for choregraphing a process to align with task urgency 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The examples herein include computer-implemented methods, computer program products, and computer systems that comprise program executing on one or more processors that extends a process model, including but not limited to a BPM model, to sense the transaction urgency and align all the components in the system to execute the transaction on priority. In the examples herein, program code executing on one or more processors utilizes an LLM to identify an urgency and/or sentiments level of a transaction at a point (e.g., origin point, other point, etc.) of the transaction (e.g., at a request point). Based on determining the urgency or sentiment level, the program code initializes a protocol manager to augment additional parameters to accommodate the request in view of the urgency and/or sentiment level handle the request. Program code comprising an LLM based depth control manager tunes the configuration of the LLM model or of a traditional AI model to accommodate the urgency level of the transaction. In some examples, the program code identifies changes in a process, including in a BPM model (e.g., addition and/or removal of nodes) and re-initiates the learning of the new environment. As such, in the examples herein, program code executing on one or more processors utilizes an LLM to choreograph a process model, including a BPM, such that the program code can identify the urgency of a transaction and set all the nodes to act according to the urgency level.

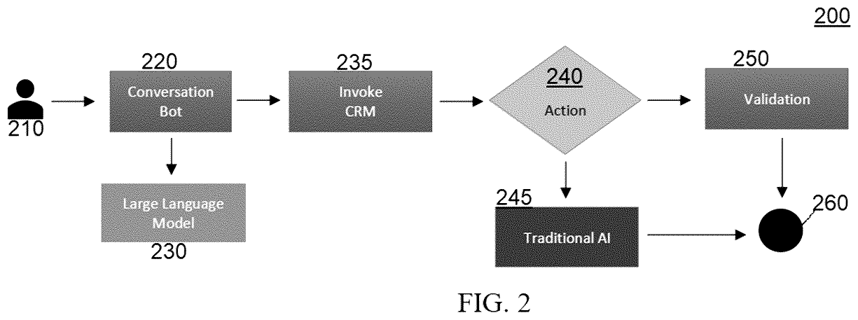

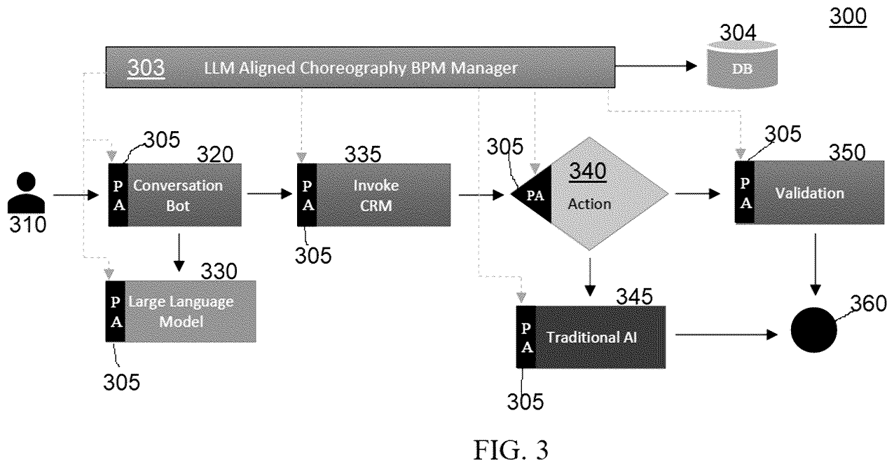

FIGS. 2-3 are BPMs. These are examples of a type of process model 200 300 into which the examples herein can be integrated. FIG. 2 is a sample BPM that does not include aspects of the examples herein. Meanwhile, FIG. 3 includes aspects of the examples herein, including program code represented by a component labeled an LLM aligned choreography BPM manager.

FIG. 2 illustrates a BPM 200 in which a user 210 initially interacts with a conversation bot 220, acting as an interface to an LLM 230. The program code invokes a CRM 235 based on this interaction (e.g., the user may have requested customer information via the conversation bot 220). Based on the CRM interaction and what is presented to a user via an interface, the user makes an input or takes another type of action 240 (e.g., via an interface such as a graphical user interface (GUI) and/or a host controller interface (HCI)). The program code then validates the user entry or action 250, and the process terminates 260. The action 240 taken by the user can be enhanced based on the interface (e.g., HCI) being couple with a traditional AI 245 system. Traditional AI use cases typically focus on predicting future outcomes or classifying a category based on an AI model that's trained on existing historical data sources like tabular data and images. In this example, an HCI could communicate with traditional AI 245 such that the traditional AI 245 could provide autocomplete or type-ahead, to allow faster entry of the action 240 by the user.

In FIG. 3, program code executing on one or more processors is referred to as a protocol agent (PA) 305 shepherds a user and system components through a process to complete a transaction in the BPM 300. As illustrated in FIG. 3, the (program code comprising the) PA 305 is attached to every component in the model (e.g., BPM 300) and interacts between aspects of the method and the component that provides the program code with the priority and identifies the component type based on the dependency graph. Based on the component type, the program code comprising the protocol agent can determine that a component or portion of a process can be skipped based on the LLM determining that the transaction is of a given priority (e.g., high priority).

In FIG. 3, program code comprising a centralized LLM aligned choreography manager 303 interacts with all the components in the BPM 300 via the program code comprising the PA 305 to set the transaction urgency level and other parameters for a particular transaction. Although illustrated as two Mouths, as illustrated in FIG. 3, the program code (of the LLM aligned choreography manager 303 and the PA 305 can change the process based on determining that the transaction is of a given priority. For example, if the program code determines that the transaction is not of a threshold priority to change the BPM 300, in this example, as with FIG. 2, a user 310 initially interacts with a conversation bot 320, acting as an interface to an LLM 330. The program code invokes a CRM 335 based on this interaction. Based on the CRM interaction and what is presented to a user via an interface, the user makes an input or takes another type of action 340 (e.g., via an interface such as a graphical user interface (GUI) and/or a host controller interface (HCI)). The program code then validates the user entry or action 350, and the process terminates 360. As with FIG. 2, the action 340 taken by the user can be enhanced based on the interface (e.g., HCI) being coupled with a traditional AI 345 system. However, should, for example, based on the user 310 initially interact with a conversation bot 320, the program code of the LLM aligned choreography manager 303 and the PA 305 determine that that the transaction is of a threshold higher priority, the program code can change the choreography of the BPM 300, for example, by skipping validating the user entry or action 350 before termination 360 the process. The program code of the LLM aligned choreography manager 303 can access a database 304, which is an operational database.

As illustrated in FIG. 2, which can be understood as a traditional BPM 200 model, the components of the model act in siloes and a transaction on arrival is processed sequentially as configured. In FIG. 3, the program code comprising the LLM aligned choreography manager 303 and the PA 305 choreograph the runtime of a transaction by interacting with all components of the BPM 300. The program code of the LLM aligned choreography manager 303 and the PA 305 can help alter or update the execution paths of transactions based on priority. Two ways in which the program code in FIG. 3 (and examples like it) can alter or update the execution paths of transactions based on priority are via centralized communication and/or sequential communication.

In the BPM 300 of FIG. 3 the protocol agent 305 feeds in a priority at component levels (centrally and/or sequentially) and the LLM 330 leverages priority embeddings related to this urgency. Returning to the example where the end customer's direct relative encounters an accident and requires urgent (time-sensitive) medical attention utilizing the system for processing claims, the responses provided to a user (providing input) from the LLM 330 can vary based on the PA 305 providing the priority to the different components and the LLM aligned choreography manager 303 adjusting the workflow. For example, in the non-limiting examples of the claims system, the LLM 330 may tailor the response to the context of urgency and also provide additional information of approved hospitals nearby. If there are no approved hospitals nearby, the program code can suggest the nearest clinical facility and initiate a process to approve the insurance at this facility as the program code determined that this is an urgent and high priority case.

In examples where the program code updates transaction execution choreography utilizing centralized communication, when the program code (utilizing an LLM) determines, on arrival, that a task is of a high (e.g., pre-determined threshold) priority, the program code defines the task with its protocol parameters and broadcasts the task and parameters to the components in the BPM (e.g., BPM 300) to prepare the components for the high priority task execution. The program code can implement this approach in transactions and the of this approach utility includes completing these transactions with minimum latency (e.g., providing services to a premium customer). The centralized approach enables the components of the BPM 300 to free their queues for the incoming transaction and save the current transactions in intermediate stages, as configured.

In examples where the program code update transaction execution choreography utilizing sequential communication, when the program code (utilizing an LLM) determines, on arrival, that a take is of a high (e.g., pre-determined threshold) priority, the program code feeds the protocol parameters into the BPM components. Using FIG. 3 as an example, a transaction can be fed to invoke the CRM component (invoking the CRM 335) and then the program code provides the transaction to the (human) action 340 component to be processed based on the priority. Until the transaction arrives at the component, the program code of the action 340 component is not aware of the arrival of a high priority task and continues its normal execution.

Some examples can be configured to switch between centralized control and sequential control and in some cases, to automatically adapt communication techniques. The program code can also switch between centralized control and sequential control based on the priority or the type of transaction.

In the examples herein, program code executing on one or more processors identifies component types based on a dependency graph and identifying the priority of a request can help an LLM (e.g., LLM aligned choreography manager 303) derive an execution path specific to the context of the request. As a result, the BPM 300 can prioritize urgent tasks and the proposed LLM (e.g., LLM aligned choreography manager 303 and the PA 305) is an intelligent part of the BPM 300 and the BPM 300 can respond to urgency.

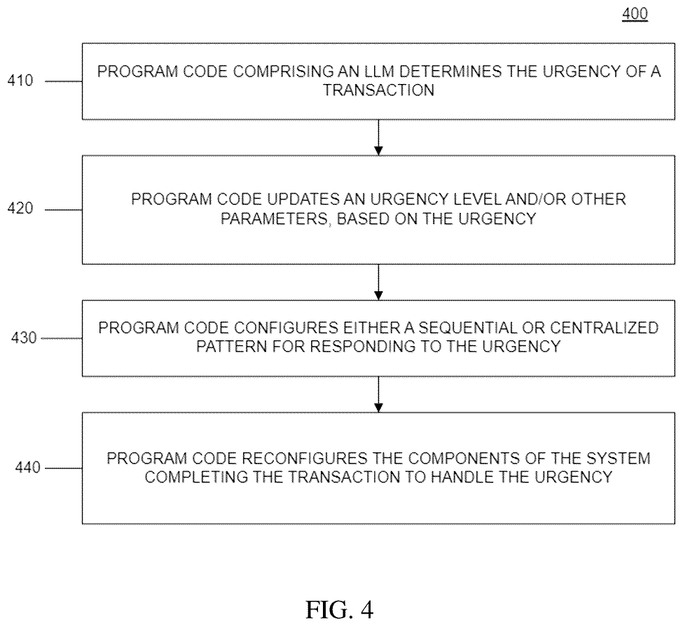

FIG. 4 is a workflow 400 that illustrates how the examples herein extend a BPM model to sense the transaction urgency and align all the components in the system to execute a transaction on priority. In these examples, program code comprising an LLM determines the urgency of a transaction (410). The program code of the LLM determines the urgency based on input provided to the program code, which can include, but is not limited to, various contextual information, such as keywords in the conversation, contextual information such as hour of the day, etc. The program code of the LLM can then deflate the content generated (input provided) or focus on just the scope of the content rather than generating more wordy or chatty or off topic content, which could have been the case in other scenarios (e.g., scenarios where the priority is not above a given threshold). The LLM can be self-learning but in some examples, it is trained before it is implemented into a BPM. The LLMs can include a layer of priority embedding and can be by different priority bands (e.g., high medium, low) and/or numerical ranges (e.g., from 0 to 10, etc.). In some examples, the LLM is trained utilizing publicly available data, such as data representing human responses to neutral situations and changes in responses in an urgent situation. The program code in the examples herein can fine tune the LLM using single-shot, few-shot, and/or multi-shot machine learning based on the priority and/or urgency criteria. Single-shot learning is a type of machine learning that allows a model to learn to classify new objects after seeing only one example of each object. Few-shot learning is a machine learning framework in which an AI model learns to make accurate predictions by training on a very small number of labeled examples. Multi-shot learning is a training in which a model (e.g., LLM) is provided with multiple examples to enable the model to learn from various instances. Multi-shot learning is utilized in situations where providing a range of examples helps the model better understand the desired outcome.

In some examples, program code executing on one or more processors can utilize natural language (NLU) and natural language processing (NLP) application programming interfaces (APIs) and/or cognitive agents to determine the priority of an input. One or more embodiments utilize, for instance, an IBM Watson® system as the cognitive agent in performing NLU. In one or more embodiments, the program code interfaces with IBM Watson Application Programming Interfaces (APIs) to perform a cognitive analysis, which includes NLU, of obtained data, in this case, of the entities. Specifically, in one or more embodiments, certain of the APIs of the IBM Watson API comprise a cognitive agent (e.g., learning agent) that includes one or more programs, including, but not limited to, natural language classifiers, Retrieve and Rank (i.e., a service available through the IBM Watson Developer Cloud™ that can surface the most relevant information from a collection of inputs, such as documents), concepts/visual insights, trade off analytics, document conversion, and/or relationship extraction. In an embodiment, one or more programs analyze the data obtained by the program code across various sources utilizing one or more of a natural language classifier, retrieve and rank APIs, and trade off analytics APIs. In one or more embodiments of the present disclosure, the program code can utilize the deep learning in IBM Watson® Natural Language Understanding both to identify entities in the sentences, to determine a sentiment for each entity, and to determine the priority of a sentiment (e.g., indicating the strength of the sentiment). IBM Watson® and IBM Watson Developer Cloud™ are registered trademarks or trademarks of International Business Machines Corporation in at least one jurisdiction.

In a scenario where the end customer's direct relative encounters an accident and requires urgent (time-sensitive) medical attention, the situation can be resolved utilizing insurance coverage details and/or approvals. The process (alignment choreography) changes based on program code executing in this system determining the priority of a task. When the customer interacts with the chatbot to enquire about the insurance details, the chatbot interacts with an underlying LLM such that the LLM can analyze the input including keywords and/or emotions such that the LLM can determine the urgency of the transaction. Once the system (utilizing the LLM) determines that the transaction is a priority transaction (based on the urgency), the system can take steps to prioritize and/or request prioritization of the transaction. For example, this system could fetch customer details from a CRM from a customer relationship management (CRM) system rather than engage in a usual process, such as a person a step-by-step validation of the customer at every stage. Also, because the system has identified the transaction as being a priority transaction, the system could perform minimal validations and proceed for approvals and processing of insurance, thus deferring the normal procedure.

Returning to FIG. 4, once the program code determines the urgency of a transaction, the program code updates an urgency level and/or other parameters, based on the urgency (420). In some examples, the parameters can include, but are not limited to, certain mandatory parameters and other optional parameters. The optional parameters can include a transaction identifier, a node identifier, in and out parameters, and urgency level. Optional parameters can include directions (e.g., array), a channel identifier, augmented information, and/or a participation flag. The program code configures either a sequential or centralized pattern for responding to this urgency (430). The program code reconfigures the components of the system completing the transaction to handle the urgency (440).

Overload avoidance is a consideration in various examples herein. In certain of the examples herein, peripheral components in the system work in a manner that is aligned to the urgency and if there is an overload of urgent tasks (e.g., five urgent tasks of urgency factor five), program code in the examples herein can utilize a tie breaker algorithm (e.g., FIFO, LIFO, etc.) to determine an order in which to reconfigure a process based on priority and urgency. In some examples, the program code can solicit priority preferences from a user and reconfigure a process to complete user-designated tasks, first.

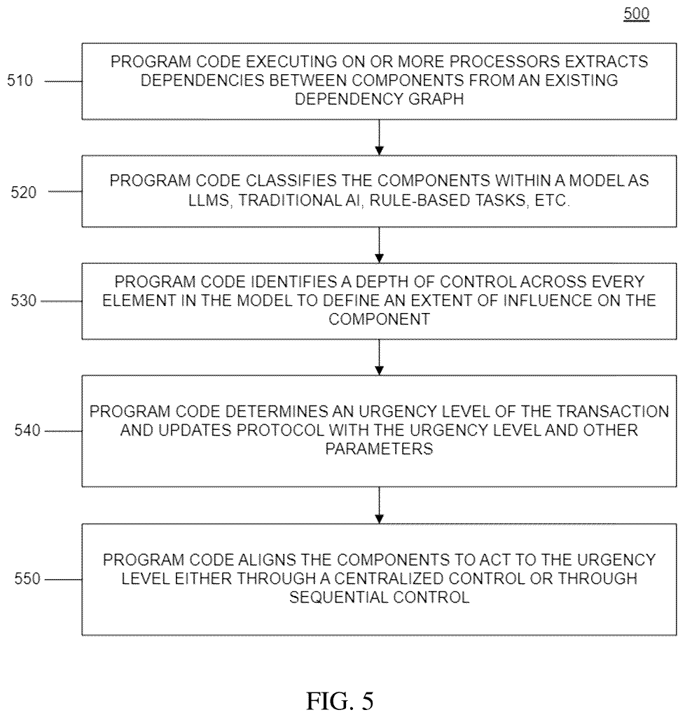

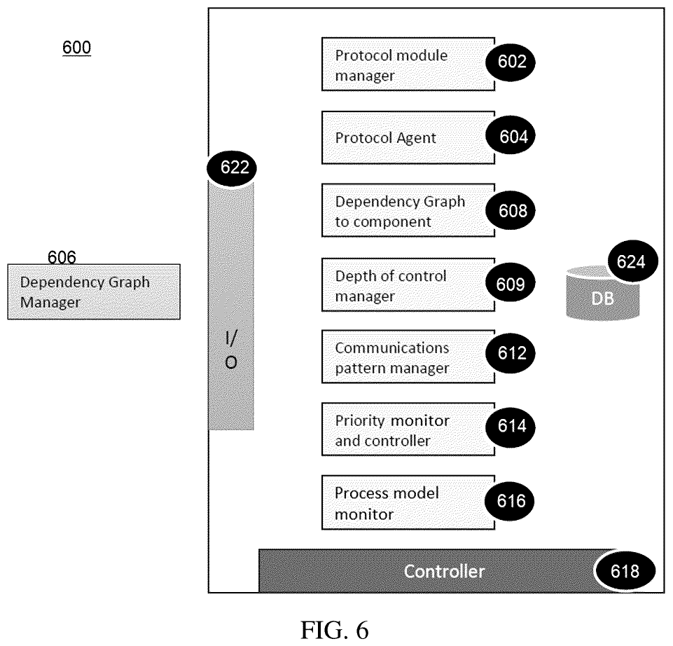

FIG. 4 illustrates the runtime process performed by the program code. For the program code to reconfigure a process at runtime, as illustrated in FIG. 4, based on determining the urgency of a transaction, in some examples, the program code can initially align components in a computing system that would perform the transaction. Thus, in the examples herein, the program code can align all components in a business process model, including peripheral components, to process and serve transactions based on their urgency (factor). FIG. 5 is a workflow 500 that illustrates certain of these initial aspects and the runtime processing of FIG. 4. Meanwhile, FIG. 6 illustrates a component diagram for various aspects of some examples herein. FIG. 6 refers to various functionalities of modules individually, however these aspects can be implemented in a single and/or multiple code modules. The separate modules are illustrated in FIG. 6 to provide a clear illustration, only. FIGS. 5-6 are discussed below to illustrate various aspects of some of the examples herein.

As illustrated in FIG. 5, program code executing on one or more processors extracts dependencies between components from an existing dependency graph (510). Various aspects of the examples herein enable the program code to extract these dependencies. Referring to FIG. 6, program code comprising a protocol module manager 602 initializes protocol across the stack and provides an extensible metadata-based protocol template for communication across the components (in addition to being a manager). The aforementioned protocol agent 604 resides in every component and is configured as per a protocol module design. The program code of the protocol agent 604 senses the urgency for the transaction and aligns all the elements to act accordingly (either through a centralized pattern or sequential pattern). In some examples, as a user starts to create BPM components, the program code of the protocol agent 604 interfaces with the protocol module manager 602. Program code comprising a dependency graph manager 606 extracts dependencies between the components in the system and their input and output data flow. In some examples, a user can trigger whether the dependency graph manager 606 can utilize an existing dependency graph and LLM capabilities classify components within the BPM tag as LLMs, traditional AI, rules-based tasks, etc.

When the program code identifies component types based on the dependency graph and identifies the priority of a request, these data can help an LLM derive an execution path specific to a context of a request. These data can assist in prioritizing an urgent task as an LLM provides intelligence when integrated in a business process model to respond to urgency. The program code classifies the components within a model (e.g., business process model tagged components) as LLMs, traditional AI, rule-based tasks, etc. (520). In some examples, a dependency graph to component 608 leverages an existing dependency graph and uses an LLM to identify the component type (LLMs, traditional AI, rules-based tasks, etc.). If an urgency was sensed by the program code in later tasks and not all previous elements would have participated, the program code can set a participation flag to reflect the portion of components impacted by the urgency. The program code identifies a depth of control across every element in the model to define an extent of influence on the component (530). Program code comprising a depth of control manager 609, in some examples, analyzes every component and qualifies the depth of its own control. The depth of control manager 609 can decide a path of flow and can determine whether the process model will utilize a centralized pattern to control the flow or flow in a sequential pattern.

The program code determines an urgency level of the transaction and updates protocol with the urgency level and other parameters (540). The program code aligns the components to act to the urgency level either through a centralized control or through sequential control (550). In some examples, a communication pattern manager 612 enables configuration of a sequential pattern of protocol or a centralized pattern. Program code comprising the communication pattern manager 612 can identify depth of control across each element in a BPM. Depth of control refers to an extent to which an apparatus has influence on an element (e.g., for an LLM, if it could be augmented with additional info to handle urgency). This element can operate based on a priority override rule and/or based on priority can choose channels for communication based on the earlier patterns of request/response with time and other factors. Hence, a priority monitor and controller 614 monitors and controls priority across a stack (e.g., the stack executing the transaction) because the program code comprising this element can sense urgency level of a transaction. A process model monitor 616 monitors for component changes and triggers initializations. The controller 618 performs orchestration and choreography of the components across the stack.

FIG. 6 also includes a database 624 and an I/O interface 622. The database 624 can be an operational database and in some examples, provide a GUI based interface via rich client or browser-based interface and can be embedded in traditional BPM tools. The I/O interface 622 can interfaces to-and-from external components.

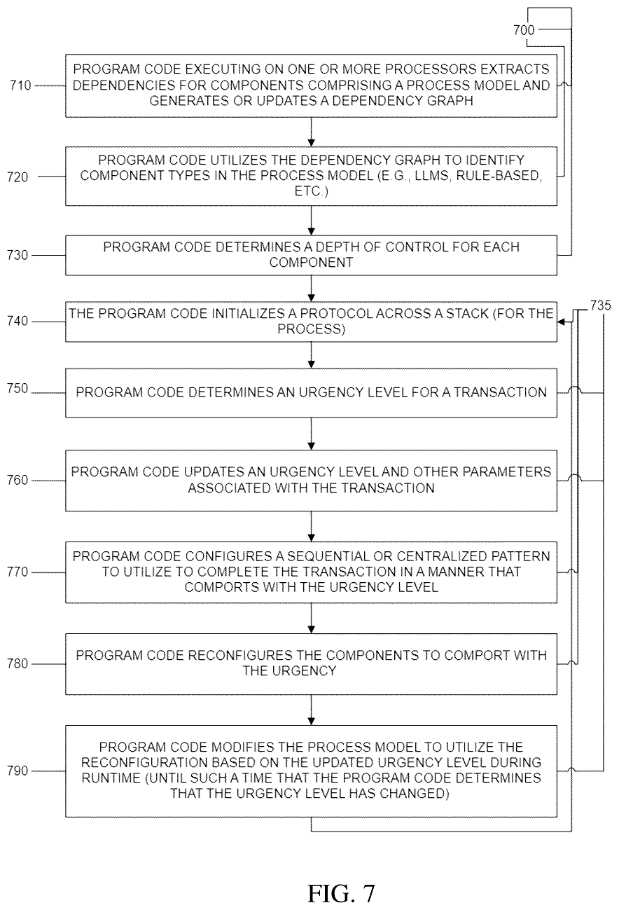

FIG. 7 is a workflow that illustrates both an initialization flow 700 and a runtime flow 735 executed by various examples herein. To initialize the process discussed herein, program code executing on one or more processors extracts dependencies for components comprising a process model and generates or updates a dependency graph (e.g., a BPM) (710). Program code utilizes the dependency graph to identify component types in the process model (e.g., LLMs, rule-based, etc.) (720). Program code determines a depth of control for each component (730).

Once the initialization is complete, the program code can perform a runtime process. The program code initializes a protocol across a stack (for the process) (740). The program code determines an urgency level for a transaction (750). The program code updates an urgency level and other parameters associated with the transaction (760). The program code configures a sequential or centralized pattern to utilize to complete the transaction in a manner that comports with the urgency level (770). The program code reconfigures the components to comport with the urgency (780). The program code modifies the process model to utilize the reconfiguration based on the updated urgency level during runtime (until such a time that the program code determines that the urgency level has changed) (790).

Although various embodiments are described above, these are only examples. For example, reference architectures of many disciplines may be considered, as well as other knowledge-based types of code repositories, etc., may be considered. Many variations are possible.

The examples herein include computer-implemented method, computer program products, and computer systems, where program code executed by one or more processors initializes the process model for runtime reconfiguration, the initializing comprises extracting dependencies for components comprising the process model. The initializing comprises generating or updating a dependency graph representing the dependencies, based on the extracting. The initializing also includes initializing, a protocol across a stack for executing the process based on the dependencies. The program code initiates the transaction. During runtime, the program code receives an input related to the transaction performed by the process model. The program code cognitively analyzes the input utilizing a large language model (LLM) to determine an urgency level for the transaction. The program code determines that the urgency level is above a pre-determined threshold. The program code reconfigures the process model to comport with the urgency level.

In some examples, the program code reconfiguring can comprise the program code implementing changes to one or more components selected from the group consisting of: omitting a component, replacing the component, and reordering the component.

In some examples, the program code reconfiguring comprises the program code implementing a new pattern to complete the transaction. The program code executes the new transaction to complete the transaction.

In some examples, the new pattern is selected from the group consisting of: a sequential pattern and a centralized pattern.

In some examples, the program code initializing further comprises the program code utilizing the dependency graph to identify component types in the process model. The program code can determine a depth of control for each component in the process model.

In some examples, the component types are selected from the group consisting of LLMs, traditional artificial intelligence (AI), and rules-based tasks.

In some examples, the program code determining the urgency level for the transaction further comprises the program code augmenting the transaction with parameters, where the reconfiguring comprises utilizing the parameters and the urgency level to reconfigure the process model.

In some examples, the parameters are selected from the group consisting of: transaction identifier, node identifier, an in and out parameter, direction, channel identifier, and participation flag.

In some examples, the program code initializing further comprising the program code identifying the components comprising the process model. The program code can implement an agent at each component of the components. The agent initializes protocol across a stack executing the process and provides an extensible metadata-based protocol template for communication across the components.

In some examples, the process model comprises a business process model.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for reconfiguring a process model to complete a transaction during runtime based on urgency, comprising:
initializing, by one or more processors, the process model for runtime reconfiguration, the initializing comprising:
extracting, by the one or more processors, dependencies for components comprising the process model;
generating or updating, by the one or more processors, a dependency graph representing the dependencies, based on the extracting; and
initializing, by the one or more processors, a protocol across a stack for executing the process based on the dependencies; and
initiating, by the one or more processors, the transaction;
during runtime, receiving, by the one or more processors, an input related to the transaction performed by the process model;
cognitively analyzing, by the one or more processors, the input utilizing a large language model (LLM) to determine an urgency level for the transaction;
determining, by the one or more processors, that the urgency level is above a pre-determined threshold; and
reconfiguring, by the one or more processors, the process model to comport with the urgency level.

2. The computer-implemented method of claim 1, wherein the reconfiguring can comprise implementing changes to one or more components selected from the group consisting of: omitting a component, replacing the component, and reordering the component.

3. The computer-implemented method of claim 1, wherein the reconfiguring comprises implementing a new pattern to complete the transaction; and
executing, by the one or more processors, the new transaction to complete the transaction.

4. The computer-implemented method of claim 3, wherein the new pattern is selected from the group consisting of: a sequential pattern and a centralized pattern.

5. The computer-implemented method of claim 1, wherein the initializing further comprises:
utilizing, by the one or more processors, the dependency graph, to identify component types in the process model; and
determining, by the one or more processors, a depth of control for each component in the process model.

6. The computer-implemented method of claim 1, wherein the component types are selected from the group consisting of LLMs, traditional artificial intelligence (AI), and rules-based tasks.

7. The computer-implemented method of claim 1, wherein determining the urgency level for the transaction further comprises:
augmenting, by the one or more processors, the transaction with parameters, wherein the reconfiguring comprises utilizing the parameters and the urgency level to reconfigure the process model.

8. The computer-implemented method of claim 7, wherein the parameters are selected from the group consisting of: transaction identifier, node identifier, an in and out parameter, direction, channel identifier, and participation flag.

9. The computer-implemented method of claim 1, the initializing further comprising:
identifying, by the one or more processors, the components comprising the process model;
implementing, by the one or more processors, an agent at each component of the components, wherein the agent initializes protocol across a stack executing the process and provides an extensible metadata-based protocol template for communication across the components.

10. The computer-implemented method of claim 1, wherein the process model comprises a business process model.

11. A computer system for reconfiguring a process model to complete a transaction during runtime based on urgency, comprising:
a memory; and
one or more processors in communication with the memory, wherein the computer system is configured to perform a method, said method comprising:
initializing, by the one or more processors, the process model for runtime reconfiguration, the initializing comprising:
extracting, by the one or more processors, dependencies for components comprising the process model;
generating or updating, by the one or more processors, a dependency graph representing the dependencies, based on the extracting; and
initializing, by the one or more processors, a protocol across a stack for executing the process based on the dependencies; and
initiating, by the one or more processors, the transaction;
during runtime, receiving, by the one or more processors, an input related to the transaction performed by the process model;
cognitively analyzing, by the one or more processors, the input utilizing a large language model (LLM) to determine an urgency level for the transaction;
determining, by the one or more processors, that the urgency level is above a pre-determined threshold; and
reconfiguring, by the one or more processors, the process model to comport with the urgency level.

12. The computer system of claim 11, wherein the reconfiguring can comprise implementing changes to one or more components selected from the group consisting of: omitting a component, replacing the component, and reordering the component.

13. The computer system of claim 11, wherein the reconfiguring comprises implementing a new pattern to complete the transaction; and
executing, by the one or more processors, the new transaction to complete the transaction.

14. The computer system of claim 13, wherein the new pattern is selected from the group consisting of: a sequential pattern and a centralized pattern.

15. The computer system of claim 11, wherein the initializing further comprises:
utilizing, by the one or more processors, the dependency graph, to identify component types in the process model; and
determining, by the one or more processors, a depth of control for each component in the process model.

16. The computer system of claim 11, wherein the component types are selected from the group consisting of LLMs, traditional artificial intelligence (AI), and rules-based tasks.

17. The computer system of claim 11, wherein determining the urgency level for the transaction further comprises:
augmenting, by the one or more processors, the transaction with parameters, wherein the reconfiguring comprises utilizing the parameters and the urgency level to reconfigure the process model.

18. The computer system of claim 17, wherein the parameters are selected from the group consisting of: transaction identifier, node identifier, an in and out parameter, direction, channel identifier, and participation flag.

19. The computer system of claim 11, the initializing further comprising:
identifying, by the one or more processors, the components comprising the process model;
implementing, by the one or more processors, an agent at each component of the components, wherein the agent initializes protocol across a stack executing the process and provides an extensible metadata-based protocol template for communication across the components.

20. A computer program product for reconfiguring a process model, the computer system comprising:
one or more computer readable storage media and program instructions collectively stored on the one or more computer readable storage media readable by at least one processing circuit to:
initialize the process model for runtime reconfiguration, the initializing comprising:
extract dependencies for components comprising the process model;
generate or update a dependency graph representing the dependencies, based on the extracting; and
initialize a protocol across a stack for executing the process based on the dependencies; and
initiate the transaction;
during runtime, receive an input related to the transaction performed by the process model;
cognitively analyze the input utilizing a large language model (LLM) to determine an urgency level for the transaction;
determine that the urgency level is above a pre-determined threshold; and
reconfigure the process model to comport with the urgency level.
